(19) United States
(12) Patent Application Publication
(10) Pub. No.: US 2002/0078007 A1
(43) Pub. Date: Jun. 20, 2002

(54) Task management program

(76) Inventor: Carlos Herrero, Catano, PR (US)

Correspondence Address: PATENT LAW OFFICES OF HEATH W. HOGLUND, 256 ELEANOR ROOSEVELT STREET, SAN JUAN, PR, 00918, US

(21) Appl. No.: 09/742,574

(22) Filed: Dec. 20, 2000

(51) Int. Cl. G06F 7/00

(52) U.S. Cl. 707/1

(57) ABSTRACT

A task management program allows a user to create contact, project and task records that are stored in a database. The contact records include an e-mail address or facsimile number. The task records are associated with a project and at least one contact. A background process periodically queries the database and automatically sends reminders to the contact(s) associated with any pending task records. A person associated with a contact may become a registered user and a new user record is added to the database. The new user is sent a unique activation code. That activation code provides the user access to existing records associated with the user's contact information. The new user may update these records.

### FIELD OF THE INVENTION

The invention generally relates to task management, and more particularly to a computer-based system and method for tracking multiple tasks allocated to a number of different users.

### DESCRIPTION OF THE RELATED ART

A wide variety of industries depend upon the coordinated efforts of a number of team members to complete a particular task. Large or complicated projects often require an effective management system to organize and coordinate the efforts of the various team members. Usually, a manager is charged with the responsibility of overseeing such a project. As the number of tasks and sub-tasks associated with a project increase, the manager must rely upon a computerized database to organize and prioritize the various responsibilities.

A variety of programs have been used to assist with the management of such projects. For example, U.S. Pat. No. 5,530,861, titled “Process Enaction and Tool Integration via a Task Oriented Pareadigm,” issued Jun. 25, 1996 to Diamant et al., U.S. Pat. No. 5,548,506, titled “Automated, Electronic Network Based, Project Management Server System, for Managing Multiple Work-Groups,” issued Aug. 20, 1996 to Srinivasan, U.S. Pat. No. 5,799,297, titled “Task Workflow Management System and Method Including an External Program Execution Feature,” issued Aug. 25, 1998, to Goodridge et al., and U.S. Pat. No. 6,035,278, titled “Method and System for Schedule and Task Management,” issued Mar. 7, 2000, to Mansour, each teach a task management or project management system. Each of these patents is incorporated herein by reference in its entirety.

Similarly, a number of programs are available on the Internet that offer functions related to project management. For example, Yahoo!® offers a calendar program, which is available at http://calendar.yahoo.com. The Yahoo!® calendar program includes a number of features such as an address book, a note pad, a to-do list, e-mail reminders, synchronization with external devices and, of course, an editable calendar. This calendar works much like a physical paper agenda. A user can set appointments, anniversaries, birthdays, classes, meetings or other events on the calendar. Each calendar event has the following parameters: title, type (appointment, meeting, etc.), date, time, duration, a single note, whether the event is repeating, a single reminder before the event (via e-mail, Yahoo!® Messenger and/or mobile device), and an invitation, which may be sent to a list of recipients at the same time as the reminder. The Yahoo!® calendar offers several sharing options including sharing with any person or with a list of Yahoo!® members.

Although this calendar can be an effective management tool, it also suffers from a number of limitations. For example, it does not allow an event to be associated with or assigned to a particular project for monitoring along with other events associated with or assigned to that same project. Events can only be searched by keywords or by event type. The program assumes that an event is completed the moment it is due. Obviously, this is not always the case. If an event is not completed by its due date and not rescheduled, they are effectively forgotten. Events cannot be assigned to another person and there is very little, if any, collaborate management of an event.

As another example, AnyDay.com™ also offers a calendar program, which is available at http://www.anyday.com. This calendar program includes a number of features such as a personal calendar, a group calendar, event entries, a to-do list and automatic reminders. The automatic reminders may be sent to a list of recipients by email and each recipients may reply to the e-mail.

Although this calendar can also be an effective management tool, it suffers from a number of limitations. For example, items on a to-do list are not shared and cannot be assigned to another person. Moreover, these items are not associated with automatic reminders and are either complete or incomplete. On many real-world projects, progress may be measured in degrees, which are not reflected by a simple binary status indicator. In regard to a recipients reply, these are not integrated into the database. To update the database, a user must make a manual entry.

Still other examples of calendar programs may be found on the Internet. These include a calendar program offered by MSN® on their web site, which is available at http://calendar.msn.com. As with the other calendar programs, this also includes a number of limitations. For example, although this calendar program allows a user to send a reminder to another person's e-mail account, it does not allow both users to view a pending to-do or task list. For collaborative projects, this type of feature is essential to effective management.

### SUMMARY OF THE INVENTION

According to one aspect of the invention, a method of operating a task management system begins by establishing an account for a first user. The task management system then receives a plurality of contacts for various team members into a database from the existing user. The task management system saves each of the contacts as records that include a unique e-mail address. The task management system then receives a project into the database from the existing user. The project is saved as a record that includes a project name and is associated with the existing user. The task management system then receives tasks into the database from the existing user. The existing user assigns each of the tasks to a project and to two or more contacts. Each of the tasks are saved as records that include a project field and contact fields. The task management system then transmits periodic reminders related to the tasks. The periodic reminders are directed to the contact's e-mail addresses. The task management system then receives a request from a new user to establish an account in the database. The new user has received one of the periodic reminders in an e-mail account associated with the new user's e-mail address. The task management system then transmits an authorization code to the new user. The authorization code is directed to the new user's e-mail address. The task management system then receives the authorization code from the new user. Finally, the task management system presents a pending task to the new user.

According to a further aspect of the invention, the task management system receives a request from the new user to update the status a pending task. The task management system updates the pending task and later presents the updated task to the same or other users.

According to a further aspect of the invention, the task management system may associate multiple e-mail addresses with a single user. To do so a unique activation code is transmitted to each e-mail address. The user must then supply each activation code to activate the respective e-mail address with the account.

According to a further aspect of the invention, a new user may update existing tasks, if the new user's e-mail account is associated with such tasks. The new user may also add notes to the pending task to alert other team members as to the status of a particular task.

According to a still further aspect of the invention, the task management system is implemented on a host computer having a database, a web server and an e-mail server.

According to another aspect of the invention, a management system receives a plurality of contacts into a database from a first user. Each contact includes a name and a unique e-mail address. The management system receives a task into the database. The task is associated with at least one of the plurality of contacts that includes the unique e-mail address. The management system then receives a new user into the database wherein the new user includes the unique e-mail address. The management system then transmits a unique access code to the unique e-mail address. The management system then receives a log-in sequence that includes the unique email address and the activation code. Finally, the management system presents tasks associated with the unique e-mail address in the database. The tasks associated with the unique e-mail address were saved in the database before the new user associated with the unique e-mail address was saved in the database.

According to a further aspect of the invention, the management system is implemented on a host computer configured to interact with network computers, wherein data is transmitted to the network computers in a format compatible with a browser interface.

According to another aspect of the invention, a database establishes a relationship between a plurality of internet users based upon their e-mail addresses. The database first receives a list of e-mail addresses from a first internet user. The database then receives a record from the first internet user that is saved in the database. The record identifies e-mail addresses from the list of e-mail addresses. The database then receives a new e-mail address from a second internet user who owns that new e-mail address. The database then compares the new e-mail address with the e-mail addresses identified in the record. Finally, the database links the new e-mail address to the record when the comparison generates a match between the new e-mail address and one of the e-mail addresses identified in the record.

### BRIEF DESCRIPTION OF THE DRAWINGS

FIG. 1 is a block diagram of one preferred implementation of a computer network.

FIG. 2 is a flow chart showing one preferred process of adding a new user to the system.

FIG. 3 is a flow chart showing one preferred mode of operation of the program to add or delete a contact, to add or delete a project, and to add or delete a task.

FIG. 4 is one preferred main user interface 400 having an options menu 410, an items pending menu 412, and a calendar 414.

FIG. 5 is one preferred add contact interface 500 that provides a form for receiving a new contact.

FIG. 6 is one preferred select contact interface 600 that provides access to a menu of existing contacts.

FIG. 7 is one preferred add project interface 700 that provides a form for receiving a new project.

FIG. 8 is one preferred select project interface 800 that provides access to a menu of existing projects.

FIG. 9 is one preferred add task interface 900 that provides a form for receiving a new task.

FIG. 10 is one preferred view task interface 1000 that provides access to a menu of pending tasks associated with a particular user.

FIG. 11 is a flow chart showing one preferred mode of operation of a background process that is used to send automatic reminders related to pending tasks.

FIG. 12 is a block diagram of one preferred database structure used to maintain users, contacts, and tasks.

### DETAILED DESCRIPTION OF THE INVENTION

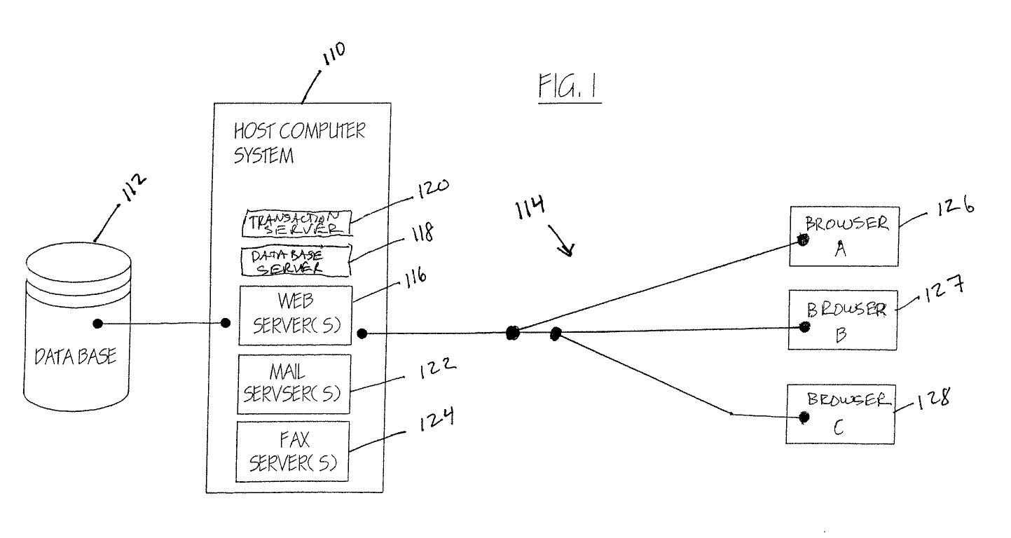

Turning to FIG. 1 one preferred computer system will be described. The computer system includes a host computer 110, a database 112 and a network 114 that provides connections to a plurality of users (or customers). The host computer includes a web server 116, a database server 118, a transaction server 120 (for purchases), a mail server 122, a fax server 124 and may include other server systems such as a wireless application server system (WAP). Although these systems are shown operating within a single computer, the host computer may include multiple computers so that each system operates on a separate computer. Likewise, multiple interconnected computers may be used to host a single system or perform the functions of any one of these servers.

A user can access host computer 110 through a browser or transaction device, shown as browsers 126-128. These connect to host computer 110 through network 114. The browser interface provides access to a variety of functions performed on the host computer. These include a to-do list where items remain pending until they are marked completed by a user. Although the items on the to-do list may include a due date, they are not removed based upon that due date.

The browser interface may be used to add items to the to-do list. These items (or tasks) may be associated with a project, a person (or contact), or a group of people who will manage the items together. The individual items may be viewed on the to-do list by due date, person, project, percent completion, task owner (or creator), or any combination of these. Moreover, the individual tasks may include associated note(s). These notes are created by the task owner or any other person associated with the task. This feature not only permits but also encourages collaborative task completion by maintaining an open communication link between different persons working on the same task. Since the item is included on a to-do list with an associated due date, the collaborative team is further encouraged to monitor progress to ensure on-time completion.

A user may add projects, tasks and contacts through the browser interface. An existing user may create a contact and assign tasks to that contact even before the associated person has activated an account on the host computer 110. For example, suppose user A has an existing account and creates a new task. That task may be assigned to person B even though person B does not have an existing account. User A simply creates a contact for person B that includes an e-mail address associated with person B. Task reminders may be sent to person B at that e-mail address. In addition, person B may subsequently register the e-mail address on the host computer 110 and become a system user. By so doing, person B may then view any assigned tasks on a to-to list through a browser interface.

By allowing an existing user to assign tasks to a non-user by use of that person's e-mail address, the system effectively encourages non-users to register with the host computer 110. The non-user will receive reminder e-mails from the host computer 110 in relation to pending tasks. Those reminder e-mails may include a message advising the non-user how to become a registered user as well as a link or address that provides the contact information for the host computer 110. By following that procedure, the nonuser may become a registered user and access directly any pending tasks associated with their e-mail address.

In fact, a registered user may view any task associated with them even if the task was created and assigned by another user. For example, if user A has assigned tasks to users B, C and D, then when any of these users B, C or D log into the host computer 110, they may view the tasks assigned to them by user A, along with any other tasks assigned by themselves or another user.

In addition to keeping users apprised of the status of a particular task through the browser interface, host computer 110 can also send reminders by the mail server 122, fax server 124 or other communications devices, including wireless devices, such as a pager or cellular telephone. This functionality is provided by an appropriate server function (not shown in FIG. 1).

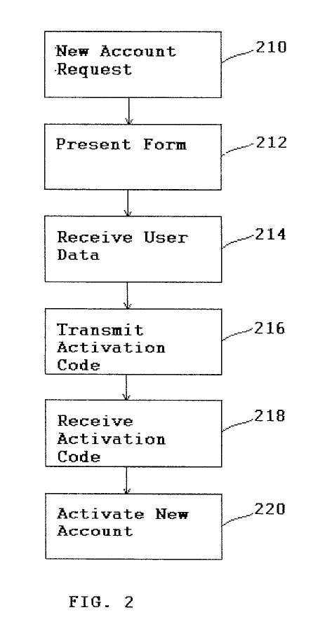

Turning to FIG. 2, one preferred method of adding a new user to the system will be described. This process begins at step 210 where the host computer receives a request to create a new account. In response, at step 212, the host computer presents a form to a browser. This form includes entries for a user name, password, e-mail address(es), and other contact information. At step 214, the host computer receives the user name, password, e-mail address(es), and other contact information entered on the form. At step 216, the host computer transmits a unique activation code to each of the user's e-mail addresses. Typically, this activation code is an alphanumeric sequence of at least six characters. To active access to items associated with a particular e-mail address, the user must then provide the authorization code back to the host computer. This improves system security because, at the very least, it ensures that the new user has access to the respective e-mail account.

At step 218, the host computer receives the authorization codes back from the new user. As each is received, the host computer activates the respective e-mail address for that user at step 220. Similarly, a facsimile or other contact information can be verified by transmitting another unique authorization code based upon the unique contact information. For example, a facsimile account can be activated by transmitting a unique authorization code to a user's facsimile number. The user then provides that authorization code back to the host computer to activate that aspect of the contact information.

Once a user has activated a new account, that user may access tasks associated with the user's e-mail address (or other unique identifier). These tasks may include tasks that were created by other users and may even include tasks that were created before the new user established the new account.

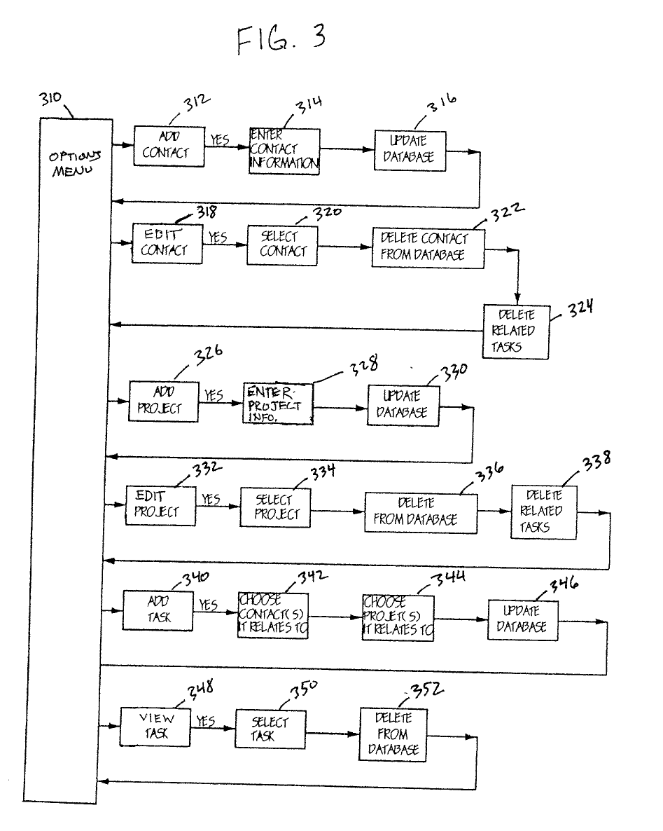

Turning to FIG. 3, the process of adding and deleting a contact, project or task is described in further detail along with the related user interfaces, which are shown in FIGS. 4-10. Each of these possibilities begins at step 310 where a user selects from an options menu. That options menu is presented to a user as part of a main user interface.

FIG. 4 shows both the main user interface 400 and the options menu 410. The options menu 410 includes an add contact, edit contact, add project, edit project, add task and view task option. Each of these text areas is active so that a user may select any one of these functions. In response the host computer presents a related interface screen that allows the user to perform the desired action. Main user interface 400 also includes a pending items menu 412 and a calendar 414. The operation of these will be described further below.

Returning to FIG. 3, the user may select the add contact option at step 312. In response, the host computer presents an add contact interface at step 314. That interface allows a user to enter the name and related contact information of another person. After establishing contact information for another person, the user may assign tasks to that person and have reminders sent to that person automatically.

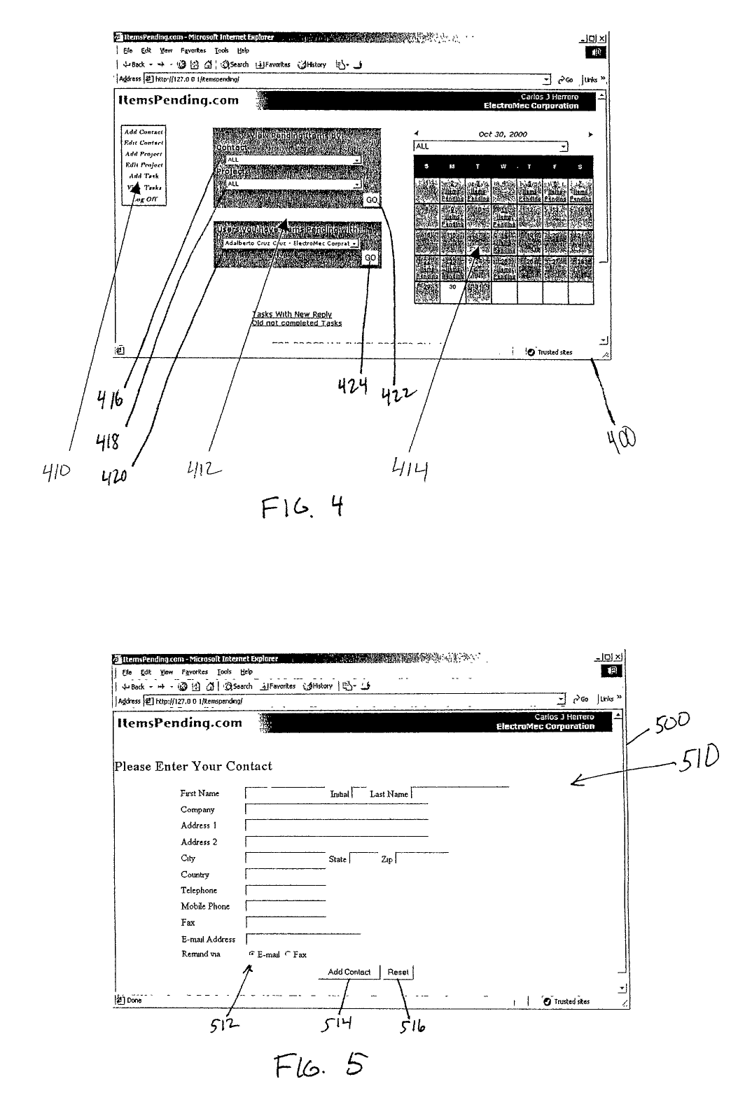

FIG. 5 shows one preferred add contact interface 500, which includes an interactive form 510. This form includes name, company, address, telephone, fax and e-mail fields. Although only one e-mail address field is shown, other embodiments may allow for multiple e-mail addresses. Add contact interface 500 also includes a communication preference switch 512. In operation, a user may select between sending e-mail or fax reminders. As shown, e-mail reminders are selected. In the case of multiple e-mail addresses, add contact interface also includes a switch for selecting between the multiple e-mail addresses or selecting all of the e-mail addresses. After a user has finished entering contact information, the user simply activates add contact button 514. This prompts the host computer to add this contact to the database. After a user has entered a contact, that user has access to the associated database record. That user may then assign projects or tasks to the contact. If the user makes a mistake while entering contact data, or decides not to enter the contact, the user may select reset button 516. This clears the form and deletes any associated data through the main user interface 400 (shown in FIG. 4).

Returning to FIG. 3, in response to a command to add a contact, the host computer updates the associated database at step 316. The process returns to step 310, and the options menu is again presented to the user.

After adding a number of contacts, a user may wish to remove certain entries that are no longer used or to update certain aspects of the information associated with a particular contact. To do so, the user simply selects the edit contact from the options menu 410 (shown in FIG. 4). In response, the host computer presents a select contact interface 600, which includes a contact selector 610, an edit button 612 and a reset button 614. The user operates the contact selector 610 to choose between the existing contacts. After making a selection, the user may choose to edit the contact information by activating the edit button 612 or to delete the contact information by activating the reset button 614. In the later case, the user is prompted to confirm that the user intends to delete the contact. If, however, the user activates the edit button 612, then the host computer presents an edit contact interface. The form of the edit contact interface is almost identical to that of the add contact interface 500, with a couple of noted exceptions. For one, the form is presented with the existing contact data from the host computer's data base. For example, the form will be presented with the contact's name, address, telephone, facsimile and e-mail address as previously stored in the database. To update this information, the user simply makes the corrections to the form. The edit contact interface also includes an update contact button, which replaces the add contact button 514 (shown in FIG. 5). When a user activates the update contact button, any changes to the form replace the previous database entry for the associated contact.

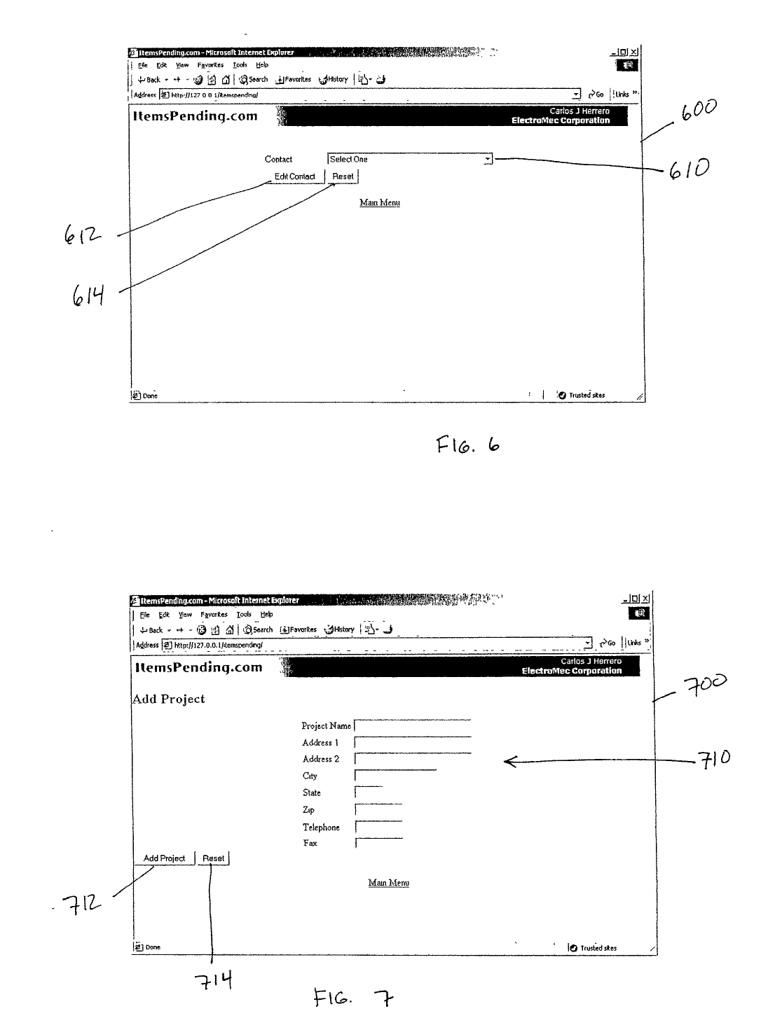

Returning to FIG. 3, the process of deleting a user is shown and described. Again, beginning from the options menu at step 310, an edit contact option is presented to the user. At step 318, the user selects the edit contact option. The host computer then presents the edit contact interface 600 (shown in FIG. 6). At step 320, the user select the desired contact from a contact menu and activates a reset (or delete) button. At step 322, the host computer deletes that contact from the database. Then, at step 324, the host computer searches for any tasks assigned to the contact that has just been deleted. Each such task is presented to the user on a delete task screen. Here, the user has the option of deleting the task from the database or assigning it to another contact. Alternatively, if the task is assigned to more than one contact, the user may simply delete that contact from that task assignment and/or assign replacement contact(s) to the task. After viewing any associated tasks, the user again returns to the options menu at step 310.

From the options menu at step 310, the user may select add project and proceed to step 326. In response, the host computer presents an add project interface at step 328. This interface prompts the user to enter project information. After receiving this from the user, the host computer updates the database at step 330, and then returns to the options menu at step 310.

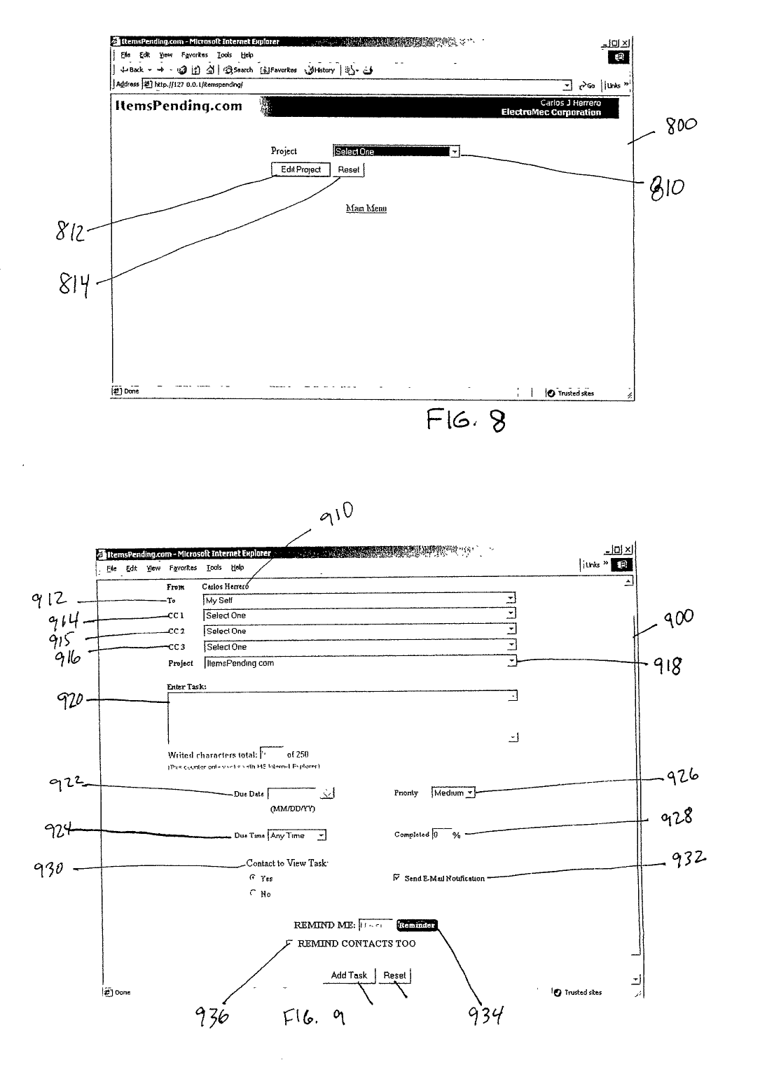

Turning to FIG. 7, one preferred add project interface 700 will be described. This includes a project form 710 that includes project name, address, telephone and facsimile fields. For example, where the task management program is used by a building contractor, a project will typically relate to a particular building or other property that is under construction. The project is assigned a name, and any available contact information is included. In addition to the fields shown, the project interface may also include a customer name (or names) and any related contact information.

After completing any (or all) of the fields in form 710, the user may select the add project button 712. In response, the host computer adds this new project to the database. The host computer then presents the main user interface. If the user wishes to clear the form 710, the user may select the reset button 714. All fields are cleared and the user may re-enter any project information.

After adding a number of projects, a user may wish to remove projects that are completed or to update any information associated with a particular project. To do so, the user simply selects edit project from the options menu 410 (shown in FIG. 4). In response, the host computer presents a select project interface 800. This includes a project selector 810, an edit button 812 and a reset button 814. The user operates the project selector 810 to choose between existing projects. After making a selection, the user may choose to edit the project information by activating the edit button 812 or to delete the project information by activating the reset button 814. In the later case, the user is prompted to confirm that the user intended to delete the project. This confirmation screen includes a list of any tasks associated with the project. If, however, the user activates edit button 812, then the host computer presents an edit project interface. The form of edit project interface is almost identical to that of the add project interface 700, with a couple of noted exceptions. For one, the form is presented with the existing project data from the host computer's database. To update this information, the user simply makes the corrections to the form. The edit project interface also includes an update project button, which replaces the add project button 712 (shown in FIG. 7). When a user activates the update project button, any changes to the form replace the previous database entry for the associated project.

Returning to FIG. 3, the process of deleting a project is shown and described. Again, beginning from the options menu at step 310, an edit project option is presented to the user. At step 332, the user selects the edit project option. The host computer then presents the select project interface 800 (shown in FIG. 8). At step 334, the user selects the desired project from a project menu and activates a reset (or delete) button. At step 336, the host computer deletes the project from the database. Then, at step 338, the host computer searches for any tasks associated with the project. Each such task is presented to the user on a delete task screen. Here, the user has the option of deleting the task from the database, assigning it to another project, or allowing the task to exist without a project association. After viewing all associated tasks, the user again returns to the options menu at step 310.

From the options menu, the user may select the add task option at step 340. In response, the host computer presents an add task interface. The user then selects the contacts to which the task relates at step 342. The user then selects the project to which the task relates and enters any related task information at step 344. After receiving the task related information, the host computer adds the new task to the database at step 346. After updating the database, the user is returned to the options menu at step 310.

After creating a number of tasks, a user may wish to delete completed tasks. To do so, the user selects the view task option at step 348. In response, the host computer presents a list of pending tasks. From this list, the user may select any of the tasks at step 350. The user may then delete that task at step 352. After updating the database, the user is again returned to the options menu at step 310. The user may then select any of the above-discussed menu options and repeat the above-described steps, as desired.

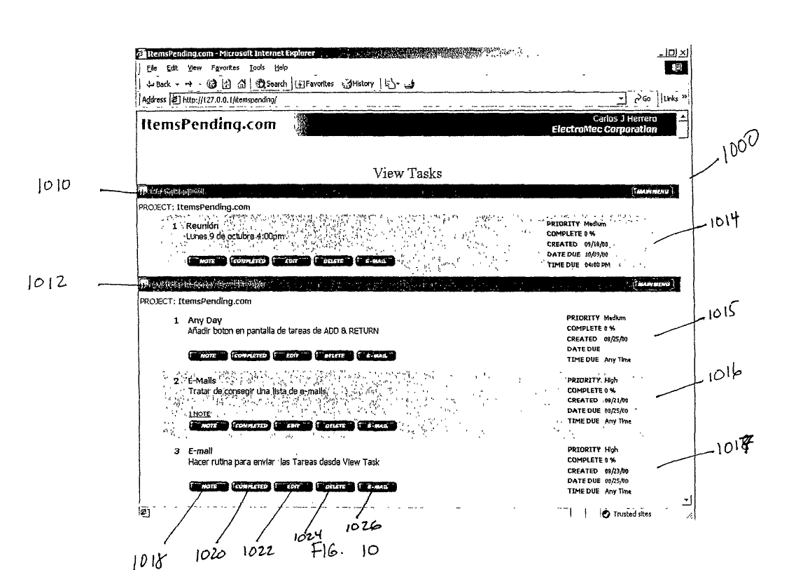

FIG. 9 shows one preferred add task interface 900, which allows a user to enter a new task. This interface includes an owner field 910. This field lists the name of the user who created the task. It also includes an assignee menu 912 and a number of co-assignee menus 914-916. The assignee menu 912 lists all of the user's contacts, including the user's own contact. From these the user must select a contact that will receive primary responsibility for the associated task. Each of the co-assignees menus 914-916 also list all of the user's contacts, including the user's own contact. From these the user may select a contact that will receive secondary responsibility for the associated task. Although these selections are optional, by allowing multiple users to be assigned to the same task, the system encourages cooperative action as between various team members.

The task interface 900 also includes a project menu 918 and a description field 920. The project menu 918 lists all projects associated with the user. From these the user selects the project with which the particular task relates. The description field 920 provides space for the user to enter a description of the task.

The task interface 900 further includes a due date menu 922, a due time menu 924, a priority menu 926 and a percent complete menu 928. The due date and due time fields allow the user to associate a completion goal for a task. These fields are optional, but if used, they will allow the task to be associated with a particular day and displayed on the user's calendar. The priority menu 926 includes a high, medium or low selection. Medium is the default. The percent complete menu is initially set to zero. As an individual or team makes progress on a particular task, this menu may be used to monitor that progress. It is an optional selection.

The task interface 900 further includes a contact view switch 930, a notification switch 932, a remind owner menu 934 and a remind contact switch 936. If the user sets the contact view switch 930 to yes, then the contacts associated with the task may view the task and may be sent reminder notifications. This setting is typically used for collaborative tasks. If the user sets the contact view switch 930 to no, then the contacts associated with the task may not view the task and will not be sent reminder notifications. This setting is used for self-assigned or personal tasks. If the notification switch is activated, then the contacts associated with the tasks are automatically sent an e-mail after the user completes the creation of the task.

The remind owner menu 934 allows the user to send automatically task notifications by e-mail or other communications medium. The remind owner menu 934 includes a selection for never, hourly, daily, weekly and monthly. For example, if the user selects weekly, then the user would receive a weekly reminder (based upon the creation date) of the pending task. If the remind contact switch 936 is set, the contacts associated with the task will also receive reminders. Otherwise, only the owner will receive such reminders.

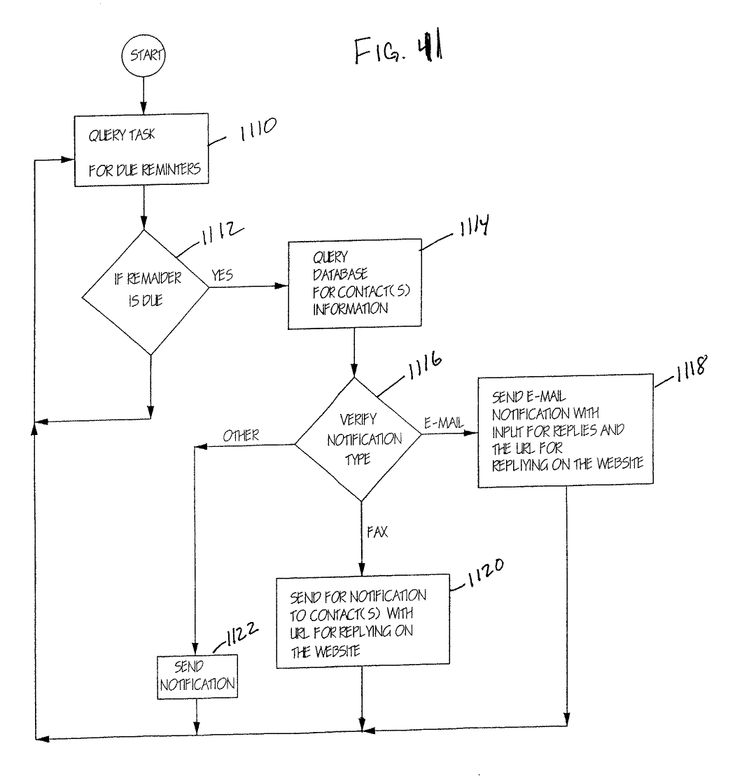

Turning to FIG. 10, one preferred view task interface 1000 will be described. In this view the tasks are listed by contact. One task is associated with the first contact 1010, three tasks are associated with the second contact 1012. Each task 1014-1017 lists the associated project, task description and related information. In addition, each task includes a note button 1018, a completed button 1020, an edit button 1022, a delete button 1024 and an e-mail button 1026. The note button 1018 allows the user to add a note that will be associated with the task record and to view notes that have already been added to the task. After adding a note, other users associated with the same task can then view that note. The complete button 1020 allows a user to update the status of a task to completion. Once this occurs, any reminder notifications will terminate and the completion status is changed to 100%. The edit button 1022 allows a user to access the task record and edit any field. The delete button 1024 allows a user to delete the task from the database. If a user performs this action, any other users associated with the task will be notified.

Returning to FIG. 4, as mentioned above, the main user interface 400 also includes a pending items menu 412 and a calendar 414. The pending items menu 412 includes a contact menu 416, a project menu 418 and a users menu 420. When a user selects the contact menu 416, a list of all of that user's contacts is presented. The user may then select one of these contacts and activate the go button 422. In response the host computer queries the database to find all tasks belonging to the user that are associated with the selected contact. These are presented to the user through an interface such as the one shown in FIG. 10.

Alternatively, the user may select the project menu 418 and view a list of all of that user's projects. The user may then select one of these projects and activate the go button 422. In response the host computer queries the database to find all tasks belonging to the user that are associated with the selected project. These are presented to the user through an interface such as the one shown in FIG. 10.

As yet another alternative, the user may select a users menu 420 and view a list of all other users that have assigned projects to him or her. The user may then select one of these other users and activate go button 424. In response the host computer queries the database to find all tasks assigned to the user by the selected other user. These are presented to the user through an interface such as the one shown in FIG. 10.

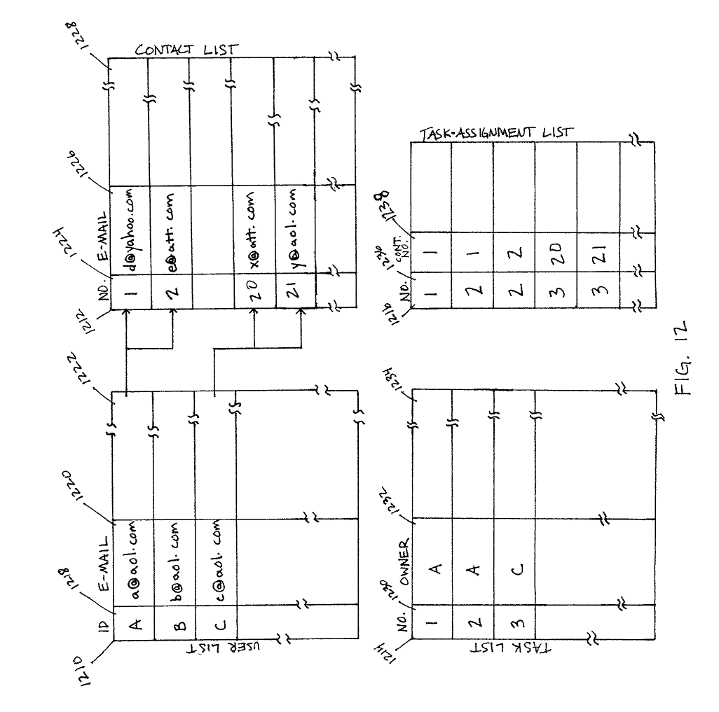

Turning to FIG. 11, the background process used to generate automatic reminder notifications will be described in further detail. This background process runs on the host computer and periodically crawls though the pending tasks in the database. This background process must run at least as often as the most frequent reminder. For example, if the most frequent reminder associated with any given task is one hour, then the background process must cycle through the tasks at least once per hour.

The process begins at step 1110, where the process selects the next pending task in the database. At decision branch 1112, the process determines whether a reminder is due for this activity. This decision is base upon the creation time for the task and the last time a reminder was sent. For example, if the reminder time is set for one week and three weeks have passed, then the process determines when the last reminder was sent. If the last reminder was sent more than one week ago, the process determines that a new reminder is due and proceeds to step 1114. Otherwise, the process returns to step 1110 to query the next pending task in the database.

At step 1114, the process determines which contacts should receive reminders. As discussed above, the task owner may be the only recipient of any reminders. Alternatively, co-assignees may also receive reminders. In any case, the process determines which contacts should receive a reminder.

At decision block 1116, the process determines what form of notification should be used for each recipient contact. If a contact should receive an e-mail notification, the process proceeds to step 1118, where the e-mail server is activated to transmit a reminder to the respective contact. If a contact should receive a facsimile notification, the process proceeds to step 1120, where the facsimile server is activated to transmit a reminder to the respective contact. Of course, other notifications are also possible. If these are selected, the process activates the appropriate server at step 1122. After sending the notification(s), the process returns to step 1110 to query the next pending task in the database.

Turning to FIG. 12, one preferred database structure used to implement the task assignments will be described. The database includes a user list 1210, a contact list 1212, a task list 1214 and a task assignment list 1216. These lists are inter-related by their entries. More specifically, user list 1210 includes an ID field 1218, an e-mail field 1220, and a number of additional fields 1222 for contact and other data. The additional fields 1222 include a link to specific entries in the contact list 1212.

When a user adds a new contact to the database, that new contact is stored as an entry in the contact list 1212. Each contact includes an ID or number field 1224, a unique e-mail address 1226, and a number of additional fields 1228 for contact or other data. These contacts may be linked to particular tasks so that the respective users are notified as to the status of a task. Users who are assigned to a task may update the status of the task in the database.

When a user adds a new task, a new entry is added to the task list 1214. Each entry on the task list includes a number or ID field 1230, an owner field 1332 and a number of additional fields that include task-related data. The task-related data may include a task description, status complete, notes or comments, project ID, and any other information associated with a task. After creating the task, a user may assign the task to a number of contacts. These are added to the task assignment list 1216. Each entry on the task assignment list includes a task number and a contact number (or ID). For example if the first task (number 1) is assigned to one contact, then the task assignment list will include only one entry for that task. If as shown, the second task is assigned to two users, then the task assignment list will include two entries for that task. Each entry will identify one of the two contacts.

One preferred software implementation is attached hereto as Appendix A. The software implementation includes a number of modules. The interaction between such modules is shown in the flow chart also included with Appendix A.

Although the invention has been described with reference to specific preferred embodiments, those skilled in the art will appreciate that many modifications are possible without departing from the spirit of the invention. All such modifications are intended to fall within the scope of the appended claims.

[image]

[image]

[image]

[image]

[image]

[image]

[image]

[image]

[image]

[image]

[image]

I claim:

1. A method of operating a task management system especially suitable for organizing a cooperative effort between team members who perform various tasks associated with a project comprising the steps of:
receiving a plurality of contacts for the team members into a database from an existing user, wherein each of the plurality of contacts are saved as records that include a unique e-mail address and are associated with the existing user;
receiving at least one project into the database from the existing user, wherein the at least one project is saved as a record that includes a project name and is associated with the existing user;
receiving a plurality of tasks into the database from the existing user, wherein the existing user assigns each of the plurality of tasks to a project and to two or more contacts, and wherein each of the plurality of tasks are saved as records that include a project field and contact fields;
transmitting periodic reminders based upon the plurality of tasks, wherein the periodic reminders are directed to the e-mail addresses associated with the contact fields so that each team member associated with a task receives a periodic reminder;
receiving a request from a new user to establish an account in the database, wherein the new user has received one of the periodic reminders in an e-mail account associated with the new user's e-mail address;
transmitting an authorization code to the new user, wherein the authorization code is directed to the new user's e-mail address;
receiving the authorization code from the new user; and
presenting at least one pending task to the new user wherein the at least one pending task is assigned to a contact that identifies the new user's e-mail address.

2. The method of claim 1, further comprising the steps of:
receiving a request from the new user to update the status of the at least one task, wherein the at least one task is pending in the database; and
updating the record associated with the at least one pending task based upon the request from the new user; and
presenting the at least one task that has been updated to the existing user.

3. The method of claim 2, wherein the request from the new user is received through a browser interface, and wherein the record is updated to include a note from the new user that may be viewed through a browser interface by the existing user or other new users assigned to the same task.

4. The method of claim 1, further comprising the steps of:
receiving a plurality of requests from new users to establish an account in the database, wherein each of the new users have received one of the periodic reminders in an e-mail account associated with the new users' e-mail addresses;
transmitting a unique authorization code to each of the new users, wherein one unique authorization code is directed to each of the new users' e-mail addresses;
receiving the authorization codes back from each of the new users; and
presenting at least one pending task to each of the new users, wherein the at least one pending task is assigned to a contact that identifies the respective new user's e-mail address.

5. The method of claim 4, further comprising the steps of:
receiving a request from each of the new users to update the status of at least one pending task; and
updating the record associated with each of the at least one pending task based upon the requests from the new users.

6. The method of claim 1, wherein the plurality of contacts are received from the existing user through a form that is presented to the existing user by a browser interface presented to a WAP device.

7. The method of claim 1, wherein the at least one project is received from the existing user through a form that is presented to the existing user by a browser interface, and wherein the form includes a field for the project name.

8. The method of claim 1, wherein the plurality of tasks are received from the existing user through a form that is presented to the existing user by a browser interface, and wherein the form includes a project field and contact fields.

9. The method of claim 1, wherein the periodic reminders are transmitted by an email server.

10. The method of claim 1, wherein the request from the new user to establish the account in the database comprises receiving a user name and a password.

11. The method of claim 1, wherein the step of transmitting an authorization code comprises transmitting a unique alphanumeric sequence.

12. The method of claim 11, wherein the step of receiving the authorization code comprises receiving the unique alphanumeric sequence.

13. The method of claim 12, wherein the step of receiving a plurality of tasks occurs prior to the steps of:
(a) receiving the request from the new user to establish the account;
(b) transmitting the authorization code; and
(c) receiving the authorization code; and
wherein the step of presenting at least one pending task to the new user occurs after the steps of:
(a) receiving the request from the new user to establish the account;
(b) transmitting the authorization code; and
(c) receiving the authorization code.

14. The method of claim 1, further comprising the steps of:
receiving a note from the new user, wherein the note is associated with the at least one pending task; and
presenting the at least one pending task and the associated note to the existing user.

15. A host computer system especially suitable for organizing a cooperative effort between team members who perform various tasks associated with a project, wherein the host computer comprises a database, a web server and an e-mail server and wherein the host computer is configured to perform the following tasks:
receive a plurality of contacts for the team members into the database from an existing user through the web server, wherein each of the plurality of contacts are saved as records that include a unique e-mail address and are associated with the existing user;
receive at least one project into the database from the existing user through the web server, wherein the at least one project is saved as a record that includes a project name and is associated with the existing user;
receive a plurality of tasks into the database from the existing user through the web server, wherein the existing user assigns each of the plurality of tasks to a project and to two or more contacts, and wherein each of the plurality of tasks are saved as records that include a project field and contact fields;
transmit periodic reminders based upon the plurality of tasks, wherein the periodic reminders are sent by the e-mail server to the e-mail addresses associated with the contact fields so that each team member associated with a task receives a periodic reminder;
receive a request from a new user to establish an account in the database through the web server, wherein the new user has received one of the periodic reminders in an e-mail account associated with the new user's e-mail address;
transmit an authorization code to the new user through the e-mail server, wherein the authorization code is directed to the new user's e-mail address;
receive the authorization code from the new user through the web server; and
present at least one pending task to the new user through the web server, wherein the at least one pending task is assigned to a contact that identifies the new user's e-mail address.

16. The host computer of claim 15 further configured to:
receive a note from the new user through the web server, wherein the note is later presented to other team members assigned to the same task through the web server.

17. The host computer of claim 15, wherein the host computer is further configured to:
receive a plurality of requests from new users to establish an account in the database through the web server, wherein each of the new users have received one of the periodic reminders in an e-mail account associated with the new users' e-mail addresses;
transmit a unique authorization code to each of the new users through the e-mail server, wherein one unique authorization code is directed to each of the new users' email addresses;
receive the authorization codes back from each of the new users through the web server; and
present at least one pending task to each of the new users through the web server, wherein the at least one pending task is assigned to a contact that identifies the respective new user's e-mail address.

18. A method of operating a task management system especially suited for use with a web-browser interface comprising the steps of:
receiving a plurality of contacts into a database from a first user wherein each contact includes a name and a unique e-mail address;
receiving a task into the database wherein the task is associated with at least one of the plurality of contacts that includes the unique e-mail address;
receiving a new user into the database wherein the new user includes the unique e-mail address;
transmitting a unique access code to the unique e-mail address;
receiving a log-in sequence that includes the unique e-mail address and the activation code; and
presenting tasks associated with the unique e-mail address in the database, wherein the tasks associated with the unique e-mail address were saved in the database before the new user associated with the unique e-mail address was saved in the database.

19. The method of claim 18, wherein the step of receiving the task further comprises receiving the task from the first user, and wherein the first user is associated with another unique e-mail address different from the unique e-mail address associated with the task.

20. The method of claim 18, wherein the step of presenting tasks comprises presenting a task that was received from the first user to the new user.

21. A method of operating a host computer configured to maintain a task-management program that may be accessed through a network browser, wherein the method comprises the steps of:
receiving a request to establish a new user account on a host computer;
receiving new user information that includes a user name, a password and an email address;
transmitting an authorization code to the new user based upon the new user information;
receiving the authorization code back from the new user; and
activating the new user account on the host computer so that the new user can access any records associated with the new user information.

22. The method of claim 21, further comprising the step of presenting records associated with the new user information through a browser interface, wherein the records were created before the step of activating the new account on the host computer.

23. The method of claim 22, further comprising the steps of:
receiving contact information from an existing user for the new user, wherein the contact information includes the e-mail address and wherein the contact information is received from the existing user before the step of activating the new user account on the host computer;
receiving a task record from the existing user wherein the task record is associated with the e-mail address; and
transmitting periodic reminders associated with the task record to the e-mail address.

24. The method of claim 23, wherein the periodic reminders are transmitted at regular intervals.

25. The method of claim 24, wherein the reminders include a link to a web server and instructions on how to activate a new account on the web server.

26. A method of establishing a relationship in a database between a plurality of internet users comprising the steps of:
receiving a list of e-mail addresses from a first internet user and saving the list in a database, wherein the list of e-mail addresses are owned by other internet users;
receiving a record from the first internet user that is saved in the database, wherein the record identifies e-mail addresses from the list of e-mail addresses;
receiving a new e-mail address from a second internet user who owns that new email address;
comparing the new e-mail address with the e-mail addresses identified in the record; and
linking the new e-mail address to the record when the comparison generates a match between the new e-mail address and one of the e-mail addresses identified in the record.

27. The method of claim 26 further comprising the steps of:
establishing a direct link though the internet between a first computer operated by the first internet user and the database; and
establishing a direct link through the internet between a second computer operated by the second internet user and the database.

28. The method of claim 26 wherein the step of linking the new e-mail address to the record comprises linking the new e-mail address through a knowledge-shared database, wherein the sharing occurs based upon the new e-mail address.

29. The method of claim 26 further comprising the step of presenting a common web page that includes the record to both the first and the second users through the internet.

30. The method of claim 26 wherein the step of linking the new e-mail address to the record comprises granting access to database resources associated with the first user.

31. The method of claim 26 wherein the step of linking occurs at least in part through a communications medium.

32. The method of claim 31, wherein the medium is voice communication.

33. The method of claim 31, wherein the medium is electronic.

34. The method of claim 31, wherein the medium is analog.
